(19) United States
(12) Patent Application Publication
(10) Pub. No.: US 2026/0159097 A1
(43) Pub. Date: Jun. 11, 2026

(54) AUTOMATIC VEHICLE INTERVENTION BASED ON OCCUPANT FACIAL EXPRESSION

(71) Applicant: Volvo Car Corporation, Göteborg (SE)

(72) Inventors: Mirta Zelenika ZEBA, Göteborg (SE); Emma NILSSON, Mölnlycke (SE); Bo SVANBERG, Landvetter (SE); Magnus BJÖRKLUND, Torslanda (SE)

(73) Assignee: Volvo Car Corporation, Göteborg (SE)

(21) Appl. No.: 18/976,573

(22) Filed: Dec. 11, 2024

(51) Int. Cl. B60W 50/00; B60W 40/08; G06V 20/59; G06V 40/16

(52) U.S. Cl. CPC B60W 50/0098; B60W 40/08; G06V 20/597; G06V 40/171; G06V 40/174; B60W 2040/0872; B60W 2420/403; B60W 2540/221

(57) ABSTRACT

In an aspect, a system is described. The system comprises: a sensor module; and a processor storing instructions in non-transitory memory that, when executed, causes the processor to: communicate a first command to the sensor module to capture one of an image and a video of one or more facial expressions of one or more occupants in a vehicle; extract one or more facial landmark characteristics from the one or more facial expressions; compare the one or more facial landmark characteristics with one or more facial baseline landmark characteristics to determine deviations; classify the one or more facial landmark characteristics based on the deviations exceeding threshold values; determine a physiological state of the one or more occupants based on the classification; and communicate a second command to an electric drive unit based on the physiological state to control the vehicle to ensure safety of the one or more occupants.

### FIELD OF THE DISCLOSURE

The present disclosure relates generally to occupant monitoring systems. More specifically, the present disclosure relates to a system and method for automatic vehicle intervention based on occupant facial expressions.

### BACKGROUND

Driver and occupant monitoring is becoming a standard feature in vehicles today and will develop even more in the future. Among the measured parameters are facial features, head, and gaze tracking. Facial feature detection by IR camera technology can be used for approximating various facial expressions.

Frequent symptoms for some illnesses exhibit different kinds of facial expressions indicating pain and/or changes in facial muscle tone (e.g., a facial drop). There are also general guidelines describing facial expressions of certain illnesses. For example, the most typical is for stroke, where one side of the face will drop down. Other medical conditions can also manifest through facial expressions, which show if the person is in pain or not in a normal state. The facial expression may thus indicate if the driver is ill and will also contain information to determine if the driver can drive or not, and may be used to implement an information, warning, or intervention strategy in the car. In addition, there are possibilities to monitor the state of the passengers to detect if or where assistance may be needed.

Therefore, there is a long-felt need for a system and method for automatic vehicle intervention based on occupant facial expressions.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate automatic vehicle intervention based on occupant facial expressions.

In an aspect, a system is described. The system comprises: a sensor module; and a processor. The processor stores instructions in non-transitory memory that, when executed, causes the processor to: communicate a first command to the sensor module to capture at least one of a first image and a first video of one or more facial expressions of one or more occupants in a vehicle; extract one or more facial landmark characteristics from the one or more facial expressions of the one or more occupants; compare the one or more facial landmark characteristics with one or more facial baseline landmark characteristics of the one or more occupants to determine deviations of the one or more facial landmark characteristics against the one or more facial baseline landmark characteristics; classify the one or more facial landmark characteristics based on the deviations exceeding threshold values; determine a physiological state of the one or more occupants based on the classification of the one or more facial landmark characteristics; and communicate a second command to an electric drive unit based on the physiological state of the one or more occupants to control the vehicle to ensure safety of the one or more occupants.

In an aspect, a method is described. The method comprises: communicating a first command to a sensor module to capture at least one of a first image and a first video of one or more facial expressions of one or more occupants in a vehicle; extracting one or more facial landmark characteristics from the one or more facial expressions of the one or more occupants; comparing the one or more facial landmark characteristics with one or more facial baseline landmark characteristics of the one or more occupants to determine deviations of the one or more facial landmark characteristics against the one or more facial baseline landmark characteristics; classifying the one or more facial landmark characteristics based on the deviations exceeding threshold values; determining a physiological state of the one or more occupants based on the classification of the one or more facial landmark characteristics; and communicating a second command to an electric drive unit based on the physiological state of the one or more occupants to control the vehicle to ensure safety of the one or more occupants.

In an aspect, a non-transitory computer readable storage medium is described. The non-transitory computer readable storage medium comprising a sequence of instructions, which when executed by a processor causes: communicating a first command to a sensor module to capture at least one of a first image and a first video of one or more facial expressions of one or more occupants in a vehicle; extracting one or more facial landmark characteristics from the one or more facial expressions of the one or more occupants; comparing the one or more facial landmark characteristics with one or more facial baseline landmark characteristics of the one or more occupants to determine deviations of the one or more facial landmark characteristics against the one or more facial baseline landmark characteristics; classifying the one or more facial landmark characteristics based on the deviations exceeding threshold values; determining a physiological state of the one or more occupants based on the classification of the one or more facial landmark characteristics; and communicating a second command to an electric drive unit based on the determined physiological state to control the vehicle to ensure safety of the one or more occupants.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system configured for automatic vehicle intervention based on occupant facial expression, according to one or more embodiments.

FIG. 2 illustrates a method for automatic vehicle intervention based on occupant facial expression, according to one or more embodiments.

FIG. 3 illustrates a non-transitory computer readable storage medium for automatic vehicle intervention based on occupant facial expression, according to one or more embodiments.

FIGS. 4A and 4B illustrate a flowchart describing automatic vehicle intervention based on occupant facial expression, according to one or more embodiments.

FIG. 5 illustrates a system monitoring whether there is a change in physiological state of an occupant, according to one or more embodiments.

FIG. 6 illustrates a system detecting an incapacitation state of a driver with high certainty, according to one or more embodiments.

FIG. 7 illustrates a system detecting a normal state of a driver, according to one or more embodiments.

FIG. 8A shows a structure of the neural network/machine learning model with a feedback loop.

FIG. 8B shows a structure of the neural network/machine learning model with reinforcement learning.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship between the client and server arises by virtue of computer programs running on the respective computers and having a client-server relationship with each other.

Embodiments may comprise or utilize a special purpose or general-purpose computer including computer hardware. Embodiments within the scope of the present disclosure may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the disclosure can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together into a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

The following terms and phrases, unless otherwise indicated, shall have the following meanings.

As used herein, the term “sensor module” refers to a unit that contains components or circuits in addition to the sensors. The additional components or circuits make the sensor easy to use. The sensor module may be an integrated circuit comprising additional components and sensors adaptable for an application. The one or more cameras may operate to monitor facial expressions of one or more occupants. In an embodiment, the sensor module may comprise one or more sensors that operate functionally together. For example, the one or more cameras and the one or more sensors within the sensor module are integrated with one another to monitor facial expressions of one or more occupants and to determine and correlate with physiological state of the one or more occupants.

As used herein, the term “electric vehicle (EV)” refers to an automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets and roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four-or more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4, 545 kg gross vehicle weight.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

As used herein, the term “vehicle computer system” refers to an embedded system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “machine learning” refers to algorithms that give a computer the ability to learn without being explicitly programmed, including algorithms that learn from and make predictions about data. Machine learning algorithms include, but are not limited to, decision tree learning, artificial neural networks (ANN) (also referred to herein as a “neural net”), deep learning neural network, support vector machines, rules-based machine learning, random forest, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. Statistical modelling relies on finding relationships between variables (e.g., mathematical equations) to predict an outcome. The ANN may be featured with a feedback loop to adjust the system output dynamically as it learns from the new data as it becomes available. In machine learning, backpropagation and feedback loops are used to train the AI/ML model improving the model's accuracy and performance over time.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service, of the emergency-reporting vehicle.

As used herein, the term “message structure” refers to a structure of a communication message when a query and fetch operation occurs. It comprises a payload and a header, where the payload includes the quantitative value of the information that is shared, and the header includes reference to the information being shared. The message structure acts as a superstructure to accommodate any sub protocol structure such as AMQP, MQTT, Zigbee, etc.

As used herein, the term “artificial intelligence engine” refers to any system that perceives its environment and takes actions that maximize its chance of achieving its goals. An artificial intelligence unit utilizes a plurality of machine learning algorithms that allow systems to automatically improve through experience.

As used herein, the term “communication system” or “communication module” as used herein refers to a system which enables the information exchange between two points. The process of transmission and reception of information is called communication. The major elements of communication include but are not limited to a transmitter of information, channel or medium of communication and a receiver of information.

As used herein, the term “artificial intelligence (AI)” refers to the intelligence demonstrated by machines, as opposed to the natural intelligence displayed by humans. AI research has been defined as any system that perceives its environment and takes actions that maximize its chance of achieving its goals. The term “artificial intelligence” is now described in terms of rationality and acting rationally, which does not limit how intelligence can be articulated.

As used herein, the term “occupant” refers to a person seated in the vehicle. The occupant is one of a child, a kid, an adult, and an aged person. The occupant may be a driver, a passenger, etc. The occupant may exit from the vehicle. In the event of incapacitation of the occupant or the occupant exiting from the vehicle, the vehicle may operate in auto-pilot mode based on instructions received from an electric drive unit.

As used herein, the term “coordinates” refers to a set of values that shows an exact position.

As used herein, the term “deviation threshold” refers to a predefined limit or boundary that specifies how much a particular value or measurement can differ from a set norm, standard, or expected range before it triggers an alert or action. When a value exceeds this threshold, it indicates that the system or process has deviated significantly from what is considered normal, potentially requiring further investigation or corrective measures or appropriate action to be triggered.

As used herein, the term “eighty percent deviation” refers to a situation where a value or measurement differs from a reference point (such as a target, standard, or expected value) by 80%. This deviation could be positive or negative, depending on whether the observed value exceeds or falls short of the reference point. For example, if the target value is 100 and the actual value is 180, the deviation would be an 80% increase. Conversely, if the actual value is 20, it would represent an 80% decrease.

As used herein, the term “fifty percent deviation” refers to a situation where a value or measurement differs from a reference point (such as a target, standard, or expected value) by 50%. This deviation can be either an increase or decrease from the reference value. For example, if the target value is 100 and the actual value is 150, the deviation would be an 50% increase. Conversely, if the actual value is 50, it would represent an 50% decrease.

As used herein, the term “ninety-five percent deviation” refers to a situation where a value or measurement differs from a reference point (target, standard, or expected value) by 95%. This deviation can represent either an increase or a decrease, depending on whether the actual value is higher or lower than the target. For example: If the target value is 100 and the actual value is 195, the deviation would be a 95% increase. If the actual value is 5, it would be a 95% decrease.

As used herein, the term “seventy-five percent deviation” refers to a situation where a value or measurement differs from a reference point (such as a target or expected value) by 75%. This deviation can either be positive (an increase) or negative (a decrease), depending on whether the actual value is greater or smaller than the target. For example: If the target value is 100 and the actual value is 175, the deviation would be a 75% increase. If the actual value is 25, it would represent a 75% decrease.

As used herein, the term “sixty percent deviation” refers to a situation where a value or measurement differs from a reference point (such as a target or expected value) by 60%. This can either indicate a positive deviation (increase) or a negative deviation (decrease), depending on whether the actual value is higher or lower than the target. For example: If the target value is 100 and the actual value is 160, this would be a 60% increase. If the actual value is 40, this would be a 60% decrease.

As used herein, the term “Dashboard” is a type of interface that visualizes particular Key Performance Indicators (KPIs) for a specific goal or process. It is based on data visualization and infographics.

As used herein, the term “command” refers to instructions given to perform a specific function. The command may specify a particular operation such as performing arithmetic calculations, moving data between memory locations, branching to a different part of the program, or interacting with input/output devices. Commands are encoded in binary format and are represented by a sequence of bits that the appropriate module interprets and executes. The module fetches instructions and decodes them to determine the operation to perform, and then executes them accordingly.

As used herein, a “Database” is a collection of organized information so that it can be easily accessed, managed, and updated. Computer databases typically contain aggregations of data records or files.

As used herein, the term “physiological state” refers to the condition or status of the body's systems and functions of one or more occupants at a given time. The term “physiological state” encompasses various aspects of bodily functions and can be influenced by multiple factors including physical activity, stress levels, hydration, nutrition, and overall health. The physiological state may comprise one of a first incapacitation state, a second incapacitation state, and a normal state.

As used herein, the term “first incapacitation state” refers to a state of the one or more occupants in which the occupants are unable to drive the vehicle on their own. The first incapacitation state refers to a condition in which an individual is unable to perform normal driving activities or functions due to physical or mental impairment. The first incapacitation state refers to an incapacitation state with a high level of certainty.

As used herein, the term “second incapacitation state” refers to a state of the one or more occupants in which the occupants are partly able to drive the vehicle but need assistance. The second incapacitation state refers to an incapacitation state with low level of certainty.

As used herein, the term “normal state” refers to the condition in which an individual's bodily functions and systems are operating within standard or expected parameters. The normal state is characterized by the absence of significant disease, dysfunction, or abnormal conditions.

As used herein, the term “facial expressions” refers to visible movements and configurations of the facial muscles or facial parts that convey emotions, intentions, and reactions. Facial expressions are a primary means of nonverbal communication and can express a wide range of feelings from happiness and surprise to anger and sadness. Facial expressions also express an unhealthy state, a healthy state, drooping, drowsiness, etc.

As used herein, the term “facial landmark” refers to specific points on the face that are used to define the structure and position of facial features. These landmarks are essential for various applications, including facial recognition, emotion detection, animation, medical diagnosis, and more. The specific points may refer to coordinates of the facial landmarks. Some of the key facial landmarks comprise eyes, eyebrows, nose, mouth, cheeks, chin, jawline, forehead, etc. These landmarks are used to analyze facial expressions to determine emotional states.

As used herein, the term “facial baseline expressions” refers to the neutral, or resting, relaxed state of an occupant's face when they are not displaying any specific emotion or reaction. This baseline expression serves as a reference point against which other expressions can be compared to identify changes and understand emotional states. Baseline expressions vary from person to person based on individual facial structure, muscle tone, and natural resting facial posture. Factors such as age, genetics, and habitual expressions can influence a person's baseline expression.

As used herein, the term “facial baseline landmarks” refers to specific points on the face that are used as reference markers to define the structure and position of facial features in a neutral or resting state. These landmarks are crucial for various applications, including facial recognition, emotion detection, animation, medical diagnosis, and more.

As used herein, the term “deviations” refers to divergence or difference between baseline expressions and current expressions of the one or more occupants. Deviations are often quantifiable and measurable, allowing for analysis and comparison. Deviations provide insights into trends, anomalies, or patterns that may require attention or further investigation. Deviations refer to abnormalities or variations from healthy physiological states.

As used herein, the term “electric drive unit” refers to a unit that can control the operation of various devices of the vehicle (e.g., autonomous vehicle, manual driven vehicle, semi-autonomous vehicle, etc.). The electric drive unit is responsible for enabling the mobility of the vehicle. The electric drive unit refers to a system that integrates electric motors, power electronics, and control mechanisms to propel or assist in the propulsion of the vehicle.

As used herein, the term “lateral support” refers to the support/assistance provided to control the vehicle to resist sideways forces and maintain stability during cornering or maneuvers that involve lateral (side-to-side) movement. The system provides instructions to the electric drive unit to provide lateral support. The electric drive unit functions in accordance with the instructions received from the system to avoid collision.

As used herein, the term “longitudinal support” refers to the support/assistance provided to control the vehicle to accelerate, decelerate, and maintain stability in the direction of travel (forward and backward). The system provides instructions to the electric drive unit to provide longitudinal support. The electric drive unit functions in accordance with the instructions received from the system to avoid collision and ensure safety.

As used herein, the term “safe stop” refers to an action that executes the controlled and safe cessation of movement or operation of a vehicle or machinery. Safe stop involves bringing the vehicle or equipment to a halt in a manner that minimizes risks to occupants, bystanders, and property. Safe stop involves gradually reducing speed or bringing the vehicle to a complete halt in a controlled manner. Safe stop requires smooth application of brakes or other deceleration mechanisms to avoid sudden jolts or loss of control. Safe stop ensures that the vehicle stops without colliding with other vehicles, obstacles, or pedestrians.

As used herein, the term “emergency services” refers to the organizations and resources dedicated to providing immediate assistance, medical care, and protection in emergencies, disasters, accidents, and other critical situations. These services play a crucial role in saving lives, mitigating damage, and restoring safety and order.

As used herein, the term “classify” refers to categorizing or organizing things into groups based on shared characteristics or criteria. Classification involves identifying similarities and differences to create meaningful distinctions or categories.

As used herein, the term “trigger signal” refers to a signal or event that initiates or activates a particular action, process, or response in a system or device.

As used herein, a “Sensor” is a device that detects and measures physical properties from the surrounding environment and converts this information into electrical or digital signals that can be interpreted by either a human or a machine for further processing. Sensors play a crucial role in collecting data for various applications across industries. Sensors may be made of electronic, mechanical, chemical, or other engineering components. Most sensors are electronic (the data is converted into electronic data), but some are simpler, such as a glass thermometer, which presents visual data. Examples include sensors to measure temperature, pressure, humidity, proximity, light, acceleration, orientation etc. In an embodiment, sensors may be removably or fixedly installed within the vehicle and may be disposed in various arrangements to provide information to the autonomous operation features. The sensors may include one or more of a heart rate sensor, an infrared thermometer, oximeter, etc. Some of the sensors (e.g., radar, LIDAR, or camera units) may actively or passively scan the interior of the vehicle for the presence of occupants (e.g., child, adult, kids, passenger, driver, etc.) to monitor facial expressions.

The term “vehicle” as used herein refers to a thing used for transporting people or goods. Automobiles, cars, trucks, buses, etc., are examples of vehicles.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term “autonomous mode” as used herein refers to a vehicle operating mode which is independent and unsupervised.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

As used herein, the term “semi-autonomous vehicle” refers to vehicles that can operate for extended periods with little human input. A semi-autonomous vehicle cannot drive itself at all times but does automate some driving functions under ideal conditions like highway driving. A semi-autonomous vehicle may use “autopilot” features. In one embodiment, semi-autonomous vehicles may be able to keep in lane, and they may also be able to park themselves, but they are not self-driving. The semi-autonomous vehicles act independently to some degree.

As used herein the term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for information transfer of, for example a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “protocol” as used herein refers to a procedure required to initiate and maintain communication; a formal set of conventions governing the format and relative timing of message exchange between two communications terminals; a set of conventions that govern the interaction of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications within a computer system or network; a formal set of conventions governing the format and relative timing of message exchange in a computer system; a set of semantic and syntactic rules that determine the behavior of functional units in achieving meaningful communication; a set of semantic and syntactic rules for exchanging information.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products and/or data processing device which may be a core computer according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions. Some of the operations of the method may be performed in the cloud, or by some other remote server.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random-access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the memory components described of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the embodiments described. The terminology used herein best explains the principles of the embodiments, the practical application and/or technical improvement over technologies found in the marketplace, and/or enable others of ordinary skill in the art to understand the embodiments described herein.

According to aspects, the data processing capabilities of a vehicle are generally provided by a one, centralized, or more than one, communicatively coupled, core computer and optionally one or more communicatively coupled Control Units (CUs). This is generally referred to as a distributed data processing. The CUs may also act as gateways that translate and forward commands, and other information, from the core computer to the intended CU, which in turn control the behavior of a specific device or functionality. The CUs may be located in different parts of the vehicle and may be related to one or more particular functionality of the vehicle, hence, be referred to as for example Engine Control Unit (ECU), Braking (System) Control Unit (BCU), Vehicle Control Unit (VCU), Propulsion (System) Control Unit (PCU). The responsibility of the core computer is for example to coordinate and control the internal systems of the vehicle, including controlling how information is shared between the vehicle systems and various components of the vehicle. The core computer may for example be responsible for controlling torque requested/delivered by an electric propulsion motor, control friction and regenerative brakes, control internal and external lighting, and for climate control. This is generally enabled by collecting input from various sensors and systems of the vehicle, and by sending requests and instructions to different actuators of the vehicle using vehicle internal communication protocols (such as for example, but not limited to, ethernet and IPv4). The skilled person will also appreciate that at least some parts of the data processing capabilities of a vehicle may be implemented as a functionality at a remote server, for example as a functionality implemented in a cloud or edge cloud architecture, to which the vehicle internal data processing system of the vehicle is communicatively connected. For such implementations, obviously information needs to be communicated between the vehicle internal data processing system and the remote server. For the sake of simplicity, the system providing data processing capabilities is herein generally referred to as data processing device.

Business problem: The person driving a vehicle may face sudden illness. One example of a sudden illness is a stroke which can cause a person to lose the ability to control the vehicle and let the vehicle collide with nearby vehicles or other objects on the road. This may cause severe damage to the vehicle as well as the occupants of the host vehicle and the nearby vehicles. Accordingly, there remains a need for a business solution to develop a system for early detection of occupant illness or disability through monitoring facial expressions and/or physiological signs to control the vehicle to avoid collision.

Business Solution: The present system provides a cost-effective system that monitors facial expressions through camera sensors. The system may be an in-vehicle system. The system is communicatively coupled with algorithms that detect changes in physiological states of the one or more occupants from facial expressions. The in-vehicle system also comprises sensors that monitor vital signs. The in-vehicle system may correlate the detected physiological states with health conditions of the one or more occupants. The system then triggers a safety function based on the physiological states. The system can be added to any existing vehicle to implement automatic vehicle intervention based on the occupant's facial expressions.

Technical problem: If a person is suddenly ill while driving, the consequences may be severe and involve an accident. There is a need to detect facial expressions that are signs of driver incapacitation, such as facial drops on one side of the face as a sign of a stroke. While having a stroke, the driver loses the ability to drive safely and needs immediate assistance from medical services. If the illness is detected early, a vehicle safety system can inform, warn, or intervene, for example, initiate a safe stop to avoid an accident and call for assistance or medical service.

The technology for detecting various driver states, such as distraction, drowsiness, and different emotions based on head and eye tracking and facial features are available. There are also already available machine learning algorithms for detecting signs of a stroke on a face. However, there are no solutions that use tracking features to evaluate facial expressions related to changes in physiological states in the automotive setting. In addition, there are no developed in-vehicle systems that use this information to initiate safety intervention functions.

Technical Solution: Existing solutions to detect sudden illness in car drivers have focused on driver posture, gaze direction, or vital signs (e.g., heart rate and breathing). Instead, the present system detects typical signs of sudden illness with a camera system that detects certain facial expressions. The present disclosure aims to detect facial expressions that are signs of driver incapacitation, such as facial drops on one side of the face as a sign of a stroke. This can be a very important addition to the sudden illness detection, since drivers may still have an upright position, have eyes open and directed to the road ahead, and when suffering a stroke. Therefore, looking for signs of acute illness including in facial expressions will increase the number of detected cases. Other measures, such as vital signs, may also be combined with the facial expression output to enhance the performance of a detection system.

The present system performs camera-based driver monitoring to detect facial expressions that are signs of driver incapacitation. The present system can use either available algorithms for facial expression detection, or newly developed ones which are trained to enhance the detection of specific facial characteristics. The algorithms may use facial landmarks such as the nose, eyes, eyebrows, cheek, and lip line. If the algorithm detects a facial expression that indicates driver incapacitation, such as a facial drop, with a high level of certainty, then the car's safety system initiates a request to intervene, for example, an initial warning followed by a safe stop. If the algorithm detects a facial expression that indicates driver incapacitation with a lower degree of certainty, additional signs of driver incapacitation from other sensors (e.g., vital signs, posture, gaze behavior, or driving behavior) will also be incorporated in the driver state assessment before interventions are initiated. Different interventions can be triggered depending on the level of certainty in the driver state classification. For example, systems for lateral and longitudinal support can be activated already at low levels of certainty, while response requests may be initiated at a somewhat higher level of certainty.

Technical Result: The processor monitors facial expressions. The facial expressions are analyzed to determine changes in physiological state of one or more occupants. In an embodiment, the processor determines signs of illness based on physiological states. The processor compares changes in physiological states with signs of illness to ensure medical status of the occupants. The processor then communicates instructions and commands to the electric drive unit to trigger safety functions. The safety function may be one of initiating safe stop, calling emergency services, providing lateral longitudinal support. The processor may also prohibit override functions upon initiating safety functions.

### Technical Details Specific to the Technical Solution

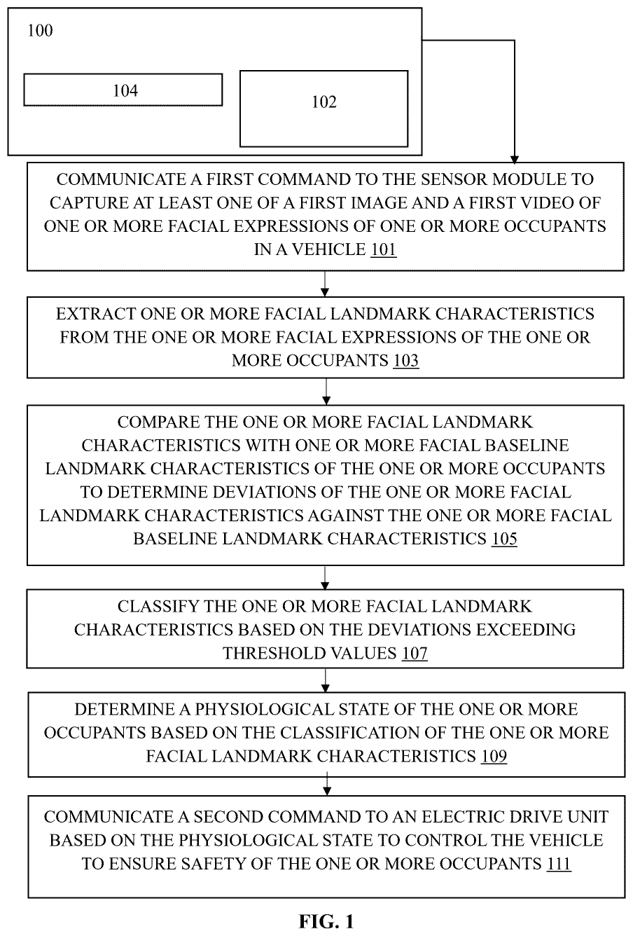

In an aspect, a system is described. As an example, FIG. 1 illustrates a system 100 configured for automatic vehicle intervention based on occupant facial expression, according to one or more embodiments. The system 100 comprises: a sensor module 102; and a processor 104. The processor 104 stores instructions in non-transitory memory that, when executed, cause the processor 104 to: communicate a first command to the sensor module to capture at least one of a first image and a first video of one or more facial expressions of one or more occupants in a vehicle (at step 101); extract one or more facial landmark characteristics from the one or more facial expressions of the one or more occupants (at step 103); compare the one or more facial landmark characteristics with one or more facial baseline landmark characteristics of the one or more occupants to determine deviations of the one or more facial landmark characteristics against the one or more facial baseline landmark characteristics (at step 105); classify the one or more facial landmark characteristics based on the deviations exceeding threshold values (at step 107); determine a physiological state of the one or more occupants based on the classification of the one or more facial landmark characteristics (at step 109); and communicate a second command to an electric drive unit based on the physiological state to control the vehicle to ensure safety of the one or more occupants (at step 111). In an embodiment, the electric drive unit may be an electronic control unit that is configured to communicate with and/or control various components of the vehicle. The vehicle may be an autonomous vehicle, a semi-autonomous vehicle, and a manual driven vehicle. The vehicle may also be one of an electric vehicle, an internal combustion engine vehicle, and a hybrid vehicle. The vehicle may also be any kind of a vehicle such as one of a car, a truck, a heavy vehicle, a commercial vehicle, a locomotive, etc.

The processor 104 requires information such as facial baseline landmark characteristics to determine the deviations of the one or more facial landmark characteristics against the one or more facial baseline landmark characteristics. The one or more facial baseline landmark characteristics are measured when the occupant is in a normal state. The one or more facial baseline landmark characteristics are utilized as reference characteristics or standard characteristics. The processor 104 measures the one or more facial baseline landmark characteristics by executing the following technical steps. The processor 104 communicates a third command to the sensor module to capture at least one of a second image and a second video of one or more facial baseline expressions of the one or more occupants in a normal state. The processor 104 then extracts the one or more facial baseline landmark characteristics from the one or more facial baseline expressions. The processor 104 is operable to determine first coordinates of the one or more facial baseline landmark characteristics. The processor 104 is further operable to determine second coordinates of the one or more facial landmark characteristics. The processor 104 then compares the first coordinates and the second coordinates (e.g., using Convolutional Neural Network (CNN)) to determine the deviations of the one or more facial landmark characteristics against the one or more facial baseline landmark characteristics.

The processor 104 classifies the one or more facial landmark characteristics based on the deviations exceeding threshold values. In an embodiment, the processor 104 via artificial intelligence engine classifies the one or more facial landmark characteristics under one or more categories (e.g., pain, sadness, drowsiness, anger, etc.) based on the deviations. The artificial intelligence engine analyzes the deviations of the facial landmark characteristics and converts them into descriptions. In an embodiment, the processor 104 adds the descriptions of the key changes in the appearance of the face to emphasize the focus of the relevant areas (e.g., ‘In this image, the eyebrows are important for the classification of pain’), and to clarify specific characteristics of features (e.g., ‘The eyebrows are lowered’). The processor 104 identifies and extracts keywords from the descriptions. The processor 104, using natural language processing techniques, converts the descriptions into numerical features. The processor then classifies the one or more facial landmark characteristics based on the deviations exceeding threshold values using the numerical features (using natural language processing) and the image features (using Convolutional Neural Network). The processor 104 determines whether the facial expressions comprise one of facial drooping and pain-related facial expressions. In an embodiment, the processor 104 is capable of comparing the facial landmark characteristics with facial baseline landmark characteristics using within-subject design to improve detection. In an embodiment, the processor 104 determines the physiological state (indicative of pain or facial drooping) based on the deviations exceeding threshold values. Based on the deviations exceeding threshold values, the processor 104 categorizing or classifying the facial landmark characteristics under one of facial drooping, pain, drowsiness, sadness, anger, etc. improves the sensitivity and specificity of the detection.

The processor 104 then determines the physiological state as a first incapacitation state when at least eighty percent of the one or more facial landmark characteristics deviate against the one or more facial baseline landmark characteristics. The first incapacitation state is an incapacitation state with high certainty of disability of driving the vehicle. The threshold values of the first incapacitation state are the presence of five out of six facial expressions with the two highest levels of intensity, and high certainty facial drooping detection is the presence of all three symptoms. The processor 104 detecting either pain or facial drooping with high certainty changes the driver state classification to “incapacitated, high certainty”, and initiates a response request, and activates safety functions to prevent crashes. The response request requires the occupant (e.g., driver) to confirm that he/she is capable of driving, e.g., by pressing a button in response to a request to do so. If the driver fails to respond to the response request for a predefined period (e.g., 5 seconds), the processor 104, via the electric drive unit, triggers safety functions by initiating a safe stop and calling emergency services. After a response request has been initiated and until a response has been received, the processor 104 provides safety functions (when possible) to provide lateral and longitudinal control of the vehicle. The processor 104 instructs the electric drive unit to take control of the vehicle. The processor communicates an alert or informs passengers that the electric drive unit has taken control of the vehicle. In an embodiment, the processor communicates an alert or informs caretaker that the electric drive unit has taken control of the vehicle. In an embodiment, the processor may inform the passenger/caretaker the current location of the vehicle and the destination of the vehicle. In an embodiment, the processor may inform the passenger/caretaker of the real-time update regarding movement or maneuvering of the vehicle. The processor 104 prohibits the driver from overriding these safety functions with the accelerator or steering wheel until he/she has given a response to the response request or changed facial expressions so that incapacitation due to a medical emergency is no longer suspected.

In one embodiment, the processor 104 determines the physiological state as a second incapacitation state when at least sixty percent of the one or more facial landmark characteristics deviate against the one or more facial baseline landmark characteristics. The second incapacitation state is an incapacitation state with low certainty of disability of driving the vehicle. The threshold values of the second incapacitation state are the presence of two to four facial expressions of pain with the two highest levels of intensity, and the low certainty detection for facial drooping is when one or two symptoms are present. The processor 104 then classifies the physiological state as “incapacitated, low certainty” and lateral and longitudinal support is initiated, with the possibility to override.

In another embodiment, the processor 104 determines the physiological state as a normal state when at least seventy percent of the one or more facial landmark characteristics align with the one or more facial baseline landmark characteristics. The processor 104 communicates a response request to the one or more occupants through a vehicle computer system when the physiological state is a first incapacitation state.

In one embodiment, the processor 104 communicates the response request to the one or more occupants to confirm that the occupant (e.g., driver) is capable of driving. The processor 104 communicates the response request to be displayed onto a display of a dashboard. In one embodiment, the processor 104 communicates the response request to be displayed onto an external device or a personal digital assistant of the occupant. The processor 104 may receive a response as a reply to the response request. In an embodiment, the processor 104 may communicate instructions to press a button via the response request. The occupant may press the button in response to the request. In one embodiment, the processor 104 is operable to receive a response through the vehicle computer system from the one or more occupants. The processor 104, upon receiving at least one response from the occupants, determines whether the occupant (e.g., driver) is capable of driving the vehicle.

In one embodiment, the processor 104 determines the physiological state as a first incapacitation state when the processor 104 does not receive the response from the one or more occupants through the vehicle computer system within a predefined period. In another embodiment, the processor 104 determines the physiological state as a normal state when the processor 104 receives the response from the one or more occupants through the vehicle computer system within a predefined period. In one embodiment, the processor 104 triggers or executes one or more safety functions until the processor 104 receives the response from the one or more occupants. In one embodiment, the one or more safety functions comprise initiating a safe stop of the vehicle. In another embodiment, the one or more safety functions comprises initiating a call to one or more emergency services. In another embodiment, the one or more safety functions comprise providing a lateral and longitudinal support to the vehicle to avoid collision. In one embodiment, the processor 104 prohibits overriding of the one or more safety functions until the processor 104 receives the response from the one or more occupants through the vehicle computer system.

The processor 104 may communicate a request for additional information about the occupant when the physiological state is a second incapacitation state. The processor 104 requests the additional information to ensure whether the occupant (e.g., driver) is capable of driving on their own based on vital signs, e.g., posture, gaze, or driving behavior. In one embodiment, the processor 104 communicates a third command to the sensor module to measure at least one physiological parameter of the one or more occupants. The processor 104 determines the physiological state as a first incapacitation state when at least one physiological parameter of the one or more occupants indicates that the physiological state is abnormal with high certainty. The physiological parameter may comprise vital signs such as blood pressure, oxygen rate, temperature, etc. In another embodiment, the processor 104, via an artificial intelligence engine, determines the medical condition of the one or more occupants based on the physiological parameters measured. The processor 104 correlates the physiological state (e.g., second incapacitation state) with the medical condition to ensure whether the occupant is capable of driving the vehicle. Upon confirming that the occupant is not capable of driving, the processor 104 initiates executing at least one of the safety functions (as described above).

How Technical Solution is a Technological Advancement: The technical solution enables automated vehicle intervention in an emergency situation particularly when the driver state is an incapacitation state. The technical solution further enables driving assistance to the driver to initiate a safe stop with limited manual intervention. The technical solution further enables automated vehicle maneuvering, using the electric drive unit, to a hospital, or a nearby ambulance based on the driver's medical condition. The technical solution enables the host vehicle to avoid collision with other vehicles or objects in the road in emergency situations.

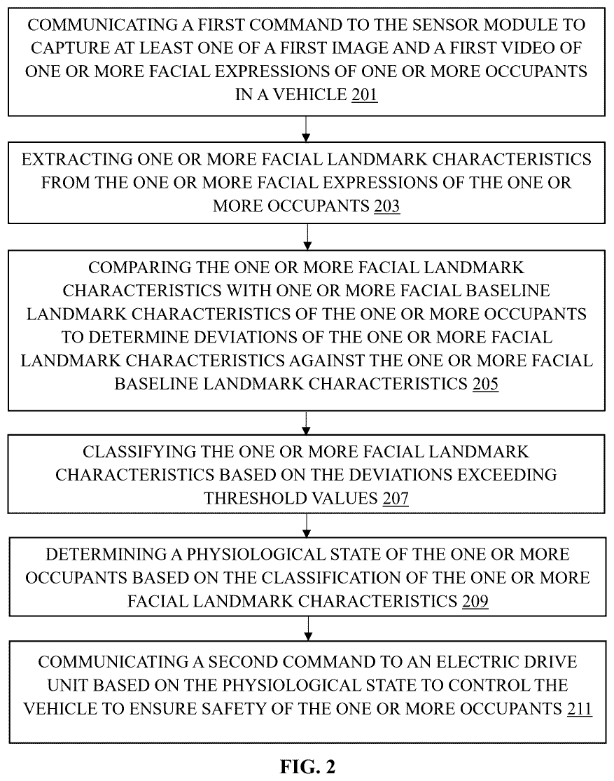

In an aspect, a method is described. As an example, FIG. 2 illustrates a method for automatic vehicle intervention based on occupant facial expression, according to one or more embodiments. The method comprises the following technical steps: communicating a first command to a sensor module to capture at least one of a first image and a first video of one or more facial expressions of one or more occupants in a vehicle (at step 201); extracting one or more facial landmark characteristics from the one or more facial expressions of the one or more occupants (at step 203); comparing the one or more facial landmark characteristics with one or more facial baseline landmark characteristics of the one or more occupants to determine deviations of the one or more facial landmark characteristics against the one or more facial baseline landmark characteristics (at step 205); classifying the one or more facial landmark characteristics based on the deviations exceeding threshold values (at step 207); determining a physiological state of the one or more occupants based on the classification of the one or more facial landmark characteristics (at step 209); and communicating a second command to an electric drive unit based on the physiological state to control the vehicle to ensure safety of the one or more occupants (at step 211).

In one embodiment, the method further comprises capturing facial baseline landmark characteristics by executing the following technical steps: communicating a third command to the sensor module to capture at least one of a second image and a second video of one or more facial baseline expressions of the one or more occupants in a normal state. The method further comprises extracting the one or more facial baseline landmark characteristics from the one or more facial baseline expressions. The method further comprises determining first coordinates of the one or more facial baseline landmark characteristics; determining second coordinates of the one or more facial landmark characteristics; and comparing the first coordinates and the second coordinates to determine the deviations of the one or more facial landmark characteristics against the one or more facial baseline landmark characteristics.

In one embodiment, the method further comprises: determining the physiological state as a first incapacitation state when the one or more facial landmark characteristics deviate against the one or more facial baseline landmark characteristics to a percentage being one of equal to and exceeding a first deviation threshold; and determining the physiological state as a second incapacitation state when the one or more facial landmark characteristics deviate against the one or more facial baseline landmark characteristics to a percentage being one of equal to and exceeding a second deviation threshold, but being below the first deviation threshold.

In one embodiment, the first deviation threshold and the second deviation threshold are dependent on the one or more facial landmark characteristics.

In one embodiment, the first deviation threshold comprises eighty percent deviation and the second deviation threshold comprises sixty percent deviation.

In one embodiment, the first deviation threshold comprises ninety five percent deviation and the second deviation threshold comprises seventy five percent deviation.

In one embodiment, the method further comprises: determining the physiological state as a first incapacitation state when at least eighty percent of the one or more facial landmark characteristics deviate against the one or more facial baseline landmark characteristics. In another embodiment, the method further comprises determining the physiological state as a second incapacitation state when at least sixty percent of the one or more facial landmark characteristics deviate against the one or more facial baseline landmark characteristics. In another embodiment, the method further comprises determining the physiological state as a normal state when at least seventy percent of the one or more facial landmark characteristics align with the one or more facial baseline landmark characteristics.

In one embodiment, the method further comprises: communicating a response request to the one or more occupants through a vehicle computer system, when the physiological state is a second incapacitation state; and receiving a response from the one or more occupants through the vehicle computer system. In one embodiment, the method further comprises: determining the physiological state as a first incapacitation state when the processor does not receive the response from the one or more occupants through the vehicle computer system within a predefined period. In one embodiment, the method further comprises: prohibiting overriding of the one or more safety functions until the processor receives the response from the one or more occupants through the vehicle computer system. In another embodiment, the method further comprises determining the physiological state as a normal state when the processor receives the response from the one or more occupants through the vehicle computer system within a predefined period of time. In another embodiment, the method further comprises executing one or more safety functions until the processor receives the response from the one or more occupants through the vehicle computer system. The one or more safety functions comprise initiating a safe stop of the vehicle. In one embodiment, the one or more safety functions comprises initiating a call to one or more emergency services. In another embodiment, the one or more safety functions comprise providing a lateral and longitudinal support to the vehicle to avoid collision.

In one embodiment, the method further comprises: communicating an additional information request to the one or more occupants through a vehicle computer system, when the physiological state is a second incapacitation state. The method further comprises communicating a third command to the sensor module to measure at least one physiological parameter of the one or more occupants. In one embodiment, the method further comprises: determining the physiological state as a second incapacitation state when the at least one physiological parameter of the one or more occupants indicates that the physiological state is abnormal.

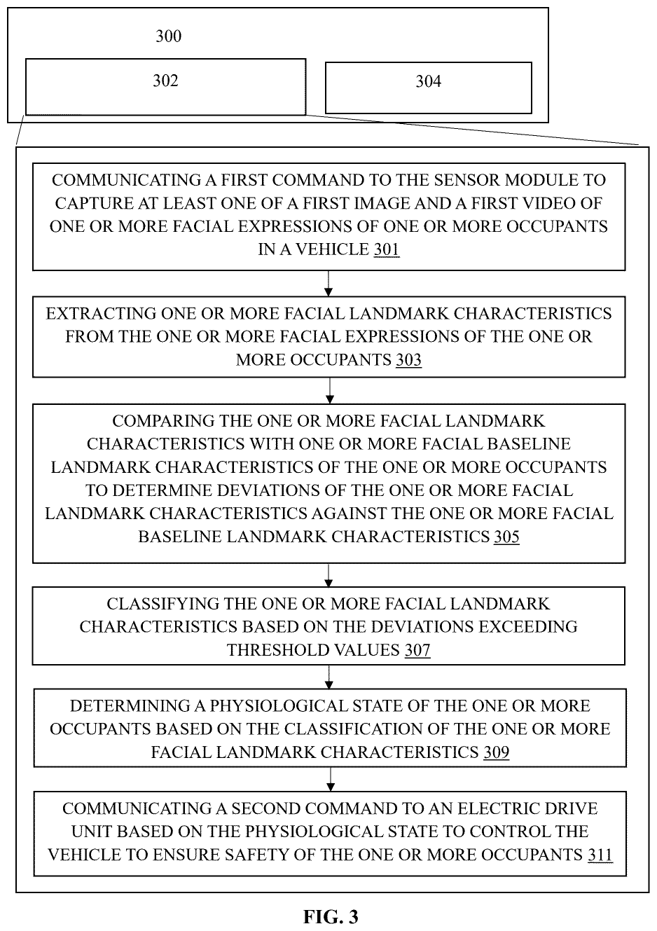

In an aspect, computer system 300 is described. The computer system 300 comprises non-transitory computer readable storage medium 302 having stored thereon instructions executable by processor 304 to perform operations as described below. As an example, FIG. 3 illustrates a non-transitory computer readable storage medium 302 for automatic vehicle intervention based on occupant facial expression, according to one or more embodiments. The non-transitory computer readable storage medium 302 comprising a sequence of instructions, which when executed by a processor 304 causes: communicating a first command to a sensor module to capture at least one of a first image and a first video of one or more facial expressions of one or more occupants in a vehicle (at step 301); extracting one or more facial landmark characteristics from the one or more facial expressions of the one or more occupants (at step 303); comparing the one or more facial landmark characteristics with one or more facial baseline landmark characteristics of the one or more occupants to determine deviations of the one or more facial landmark characteristics against the one or more facial baseline landmark characteristics (at step 305); classifying the one or more facial landmark characteristics based on the deviations exceeding threshold values (at step 307); determining a physiological state of the one or more occupants based on the classification of the one or more facial landmark characteristics (at step 309); and communicating a second command to an electric drive unit based on the physiological state to control the vehicle to ensure safety of the one or more occupants (at step 311).

In one embodiment, the non-transitory computer readable storage medium 302 further causes: communicating a third command to the sensor module to capture at least one of a second image and a second video of one or more facial baseline expressions of the one or more occupants in a normal state; and extracting the one or more facial baseline landmark characteristics from the one or more facial baseline expressions.

In one embodiment, the non-transitory computer readable storage medium 302 further causes: determining first coordinates of the one or more facial baseline landmark characteristics; determining second coordinates of the one or more facial landmark characteristics; and comparing the first coordinates and the second coordinates to determine the deviations of the one or more facial landmark characteristics against the one or more facial baseline landmark characteristics.

In one embodiment, the non-transitory computer readable storage medium 302 further causes: determining the physiological state as a first incapacitation state when the one or more facial landmark characteristics deviate against the one or more facial baseline landmark characteristics to a percentage being one of equal to and exceeding a first deviation threshold; and determining the physiological state as a second incapacitation state when the one or more facial landmark characteristics deviate against the one or more facial baseline landmark characteristics to a percentage being one of equal to and exceeding a second deviation threshold, but being below the first deviation threshold.

In one embodiment, the first deviation threshold and the second deviation threshold are dependent on the one or more facial landmark characteristics.

In one embodiment, the first deviation threshold comprises eighty percent deviation and the second deviation threshold comprises sixty percent deviation.

In one embodiment, the first deviation threshold comprises ninety five percent deviation and the second deviation threshold comprises seventy five percent deviation.

In one embodiment, the non-transitory computer readable storage medium 302 further causes: determining the physiological state as a first incapacitation state when at least eighty percent of the one or more facial landmark characteristics deviate against the one or more facial baseline landmark characteristics. In another embodiment, the non-transitory computer readable storage medium 302 further causes: determining the physiological state as a second incapacitation state when at least sixty percent of the one or more facial landmark characteristics deviate against the one or more facial baseline landmark characteristics. In another embodiment, the non-transitory computer readable storage medium 302 further causes: determining the physiological state as a normal state when at least seventy percent of the one or more facial landmark characteristics align with the one or more facial baseline landmark characteristics.

In one embodiment, the non-transitory computer readable storage medium 302 further causes: communicating a response request to the one or more occupants through a vehicle computer system; and receiving a response from the one or more occupants through the vehicle computer system. In one embodiment, the non-transitory computer readable storage medium 302 further causes: determining the physiological state as a first incapacitation state when the processor does not receive the response from the one or more occupants through the vehicle computer system for a predefined period of time. In one embodiment, the non-transitory computer readable storage medium 302 further causes: executing one or more safety functions until the processor receives the response from the one or more occupants through the vehicle computer system. In one embodiment, the non-transitory computer readable storage medium 302 further causes: prohibiting overriding of the one or more safety functions until the processor receives the response from the one or more occupants through the vehicle computer system. In one embodiment, the one or more safety functions comprise initiating a safe stop of the vehicle. In another embodiment, the one or more safety functions comprises initiating a call to one or more emergency services. In another embodiment, the one or more safety functions comprise providing a lateral and longitudinal support to the vehicle to avoid collision.

In another embodiment, the non-transitory computer readable storage medium 302 further causes: determining the physiological state as a normal state when the processor receives the response from the one or more occupants through the vehicle computer system within a predefined period of time.

In one embodiment, the non-transitory computer readable storage medium 302 further causes: communicating an additional information request to the one or more occupants through a vehicle computer system, when the physiological state is a second incapacitation state. In one embodiment, the non-transitory computer readable storage medium 302 further causes: communicating a third command to the sensor module to measure at least one physiological parameter of the one or more occupants. In another embodiment, the non-transitory computer readable storage medium 302 further causes: determining the physiological state as a second incapacitation state when the at least one physiological parameter of the one or more occupants indicates that the physiological state is abnormal.

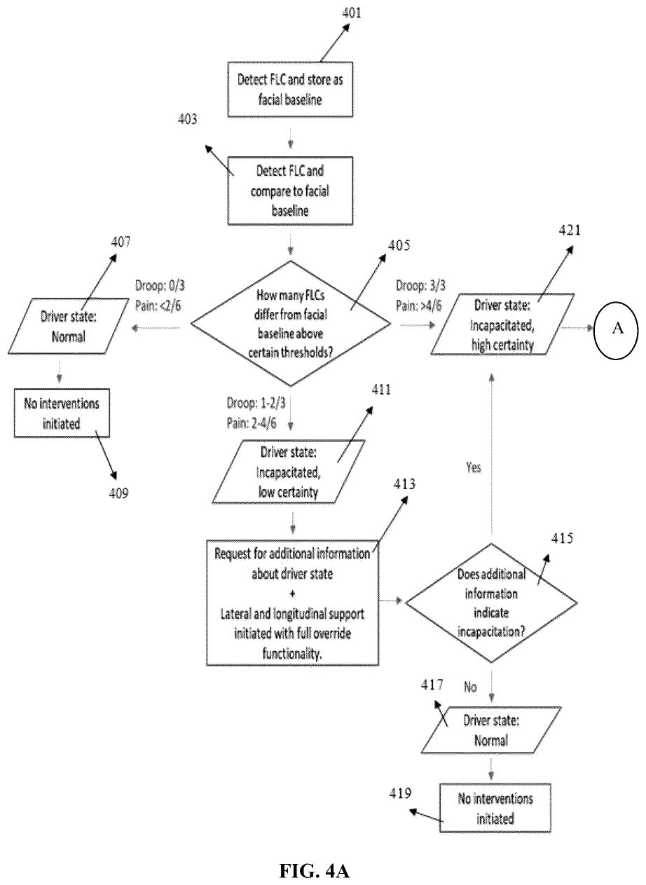

As an example, FIGS. 4A and 4B illustrate a flowchart describing automatic vehicle intervention based on occupant facial expression, according to one or more embodiments. At step 401, the processor, using a camera, captures facial baseline expressions, extracts, and stores facial baseline landmark characteristics.

The processor, using a camera, then captures the current facial expressions, and extracts the facial landmark characteristics. At step 403, the processor, using an artificial intelligence engine, compares the facial landmark characteristics to the facial baseline landmark characteristics. At step 405, the processor detects how many facial landmark characteristics (FLC) differ from facial baseline landmark characteristics above certain threshold values. At step 407, the processor detects the driver state as normal upon the presence of less than two facial expressions of pain, and when there are no symptoms of facial drooping at all. At step 409, the processor determines that no interventions are needed.

At step 411, the processor detects the driver state as incapacitation low certainty (second incapacitation state) upon the presence of two to four facial expressions of pain with the two highest levels of intensity, and the low certainty detection for facial drooping is when one or two symptoms are present. At step 413, the processor communicates a request for additional information to the one or more occupants (e.g., driver) based on the additional information (e.g., heart rate, glucose, oxygen, blood pressure (BP), etc.) and vital signs and provides lateral and longitudinal support to the vehicle. The additional information is requested to ensure that the driver can drive the vehicle though the occupant is sitting erect. At step 415, the processor determines whether the additional information indicates incapacitation. At step 417, the processor determines the driver state as normal when the additional information does not indicate incapacitation. At step 419, the processor determines that no interventions are needed.

At step 421, the processor detects the driver state as incapacitation high certainty (first incapacitation state) upon the presence of five out of six facial expressions with the two highest levels of intensity, and high certainty facial drooping detection is the presence of all three symptoms. At step 423, the processor communicates a responsiveness request to the one or more occupants (e.g., driver) and provides lateral and longitudinal support to the vehicle. At step 425, the processor receives the response and determines whether the response indicates incapacitation. The processor determines the driver state as incapacitation when the processor does not receive the response within the predefined time. In an embodiment, the processor initiates first level situation dependent assistance with limited override functionality when the responsiveness request indicates that the driver is in incapacitated. The processor may also initiate next level situation dependent assistance with limited override functionality based on contextual factors. The processor detects contextual factors based on the assistance provided. The contextual factors comprise count of vehicles, environmental condition, nearby vehicle model, nearby vehicle types, road surface condition, etc. In an embodiment, the processor monitors contextual factors to provide input to the system in the decision of which vehicle interventions/assistance shall be initiated. The contextual factors inform the system about, e.g., intervention urgency and contextual limitations. The contextual factors can be at least one of: road type, lane markings (presence and quality), weather condition, surrounding road users including pedestrians, road condition, speed limit, passengers in the car including children, distance to hospital, GPS location, vehicle limitations, etc.

At step 427, the processor initiates the safe stop and initiates emergency call. At step 429, the processor determines the driver state as normal when the processor receives the response within the predefined time. At step 431, the processor determines that no interventions are needed. In an embodiment, the processor initiates different safety functions based on the certainty level of incapacitation detected.

As an example, the technical steps for performing automatic vehicle intervention based on occupant facial expression is illustrated herein. The technical steps are detailed below. The system monitors health indicators using a sensor module. In an embodiment, the health indicators include facial expressions. In another embodiment, the health indicators include both facial expressions and vital signs. The facial expressions may be captured using a camera. The occupant may provide facial drooping or pain as facial expressions when the person has health issues. The vital signs may be monitored using other sensors. In an embodiment, the sensor module comprises both camera and other health sensors. In an embodiment, the health indicators include facial expressions/facial landmark patterns, facial weakness/drooping, posture, eye and gaze behavior, movements/spasms, facial tricks, vital signs (heart activity, breathing, blood pressure, blood oxygenation, brain activity), sounds, etc.

The processor uses the health indicators to classify driver state in terms of driver incapacitation. The health indicators can have different classification power, which provide different weight to the driver state classification. The classification power depends both on the indicator's ability to detect a medical condition (e.g., sensitivity, specificity) of the driver and on the recorded signal quality. Medical conditions that may cause incapacitation include: stroke, pain, seizure, cardiac arrest, cardiac arrhythmia, syncope/fainting/unconsciousness, severe anxiety, panic, coughing/sneezing attack, acute illness, etc.

The processor then determines whether the driver state indicates incapacitation state based on health indicators. In an embodiment, the processor utilizes algorithms to assess driver state. The processor assesses the driver state through machine learning, large language models, artificial intelligence, and/or using rules. The processor determines whether the driver state is incapacitation, high certainty or incapacitation, low certainty. The processor then determines that the driver state is normal if no health indicators suggest incapacitation, or if only a few health indicators, with low classification power, suggest incapacitation. The processor then determines that no interventions are needed and does not initiate any intervention when the driver state is normal. The processor further determines that the driver state is an incapacitation state with low certainty if one or some health indicators, with low or moderate classification power, suggest incapacitation. The incapacitation state with low certainty may be the state if the driver is sitting erect with appropriate posture. However, the processor needs to ensure that the driver can operate the vehicle safely.

The processor then communicates the command to the electric drive unit to initiate lateral and longitudinal support. The processor then requests additional information about the driver state as soon as the lateral and longitudinal support is initiated to keep the vehicle in its lane and avoid collisions. The processor provides the information to the driver about the vehicle interventions. The processor receives and analyzes the additional information to determine whether the driver state indicates incapacitation (i.e., disability to operate the vehicle). The processor determines whether the incapacitation state is with high certainty. The processor utilizes the additional information to try and improve the classification certainty and assess the situation urgently. The additional information may include: driving behavior (speed, speed in relation to speed limit, steering, lead car proximity, pedal usage, etc.); safety system warnings (forward collision warning, lane keeping aid, autonomous emergency braking, etc.); hands on wheel; movements; eye and gaze behavior; posture; health indicators with different classification power; information about the driver state provided by a passenger and/or driver, e.g., as a response to a question asking if the driver is feeling well or if the driver/passenger presses an emergency stop button, etc. In an embodiment, the processor utilizes additional information to classify the driver as Normal, as incapacitated with low certainty, or as incapacitated with high certainty.

The processor then initiates situation dependent assistance with limited override functionality. In an embodiment, the processor analyzes the traffic condition using a camera. The camera continuously captures images or videos of the surrounding environment to understand the traffic conditions to initiate situation dependent assistance with limited override functionality. With the limited override functionality, the driver cannot override the vehicle interventions with the gas pedal or steering wheel. The assistance can be one of: activating lateral and longitudinal control; limiting speed according to speed limit and environment; and initiating a safe stop. In an embodiment, the processor provides assistance by communicating instructions to the electric drive unit to restrict the vehicle speed. The driver can be actually driving but the system provides assistance by restricting the vehicle speed to at least some degree.

The processor detects contextual factors based on the assistance provided. The contextual factors comprise count of vehicles, environmental condition, nearby vehicle model, nearby vehicle types, road surface condition, etc. In an embodiment, the processor monitors contextual factors to provide input to the system in the decision of which vehicle interventions/assistance shall be initiated. The contextual factors inform the system about, e.g., intervention urgency and contextual limitations. The contextual factors can be at least one of: road type, lane markings (presence and quality), weather condition, surrounding road users including pedestrians, road condition, speed limit, passengers in the car including children, distance to hospital, GPS location, vehicle limitations, etc. The processor then initiates a responsiveness request to determine whether the driver can operate the vehicle. The responsiveness request provides information to the driver and passengers about what has been detected and what actions the vehicle will perform. The responsiveness request can be in the form of auditory and/or visual information. The processor enables both the driver and a passenger to respond to the responsiveness request, e.g., using a button or speaking (e.g., voice control). The responsiveness request may urge the driver or occupant to press a button to help determine the driver's incapacitation state. The processor determines whether the responsiveness request indicates incapacitation. If the processor receives the response within the predefined time period, the driver is in normal state. If the processor does not receive the response within the predefined time period, the driver is in incapacitation state. If the driver or passenger gives a positive response to the responsiveness request, indicating that the driver is not incapacitated, the processor reclassifies the driver state as normal and the vehicle interventions are terminated, and full control is returned to the driver in a safe way. If the driver and passenger do not respond to the responsiveness request, or if they give a negative response indicating that the driver is incapacitated, the system will initiate the next level of assistance. If the (lack of) response from the responsiveness request suggests that the driver is incapacitated, the vehicle shall initiate actions to help the driver. What actions the vehicle shall initiate depends on the contextual factors detected. The driver shall not be able to override the vehicle interventions with the gas pedal or steering wheel. Some other way to override the vehicle interventions shall be provided, e.g., by using a button or voice response. The electric drive unit enables the ability to take the following actions: perform a safe stop; call an ambulance and inform about driver symptoms, occupants in vehicle, location; drive autonomously or through remote control to meet up with an ambulance; drive autonomously or through remote control to a hospital; inform occupants of its actions; turn on warning indicators; turn on hazard lights; make a specific sound indicating incapacitated driver, etc. In an embodiment, the electric drive unit communicates with the nearby vehicles to provide commands and/or to guide the nearby vehicles to avoid collisions.

The processor initiates next level situation dependent assistance with limited override functionality when the responsiveness request indicates that the driver is in incapacitated. In one embodiment, while the driver state is classified as incapacitated with low certainty, the health indicators are continuously monitored and if they change so that incapacitation is no longer suggested, the driver state is reclassified to normal.

As an example, high-level technical steps performed by a system for performing automatic intervention of a vehicle based on occupant facial expressions is illustrated herein. The system communicates a command to the sensor module to monitor facial expressions of the one or more occupants. In an embodiment, the system further communicates a command to the sensor module to monitor vital signs of the one or more occupants. The information sensed by the sensor module is fed to the processor. The system, through one of algorithms (such as artificial intelligence, machine learning, large language models, natural language processing (NLP), etc.), detects the physiological state (e.g., medical conditions). The system determines the driver state as one of normal state, incapacitation state with low certainty, and incapacitation state with high certainty.

The system requests the driver, via the vehicle computer system, to allow/trigger an action. The system triggers the action. The action may be a safety function. The system informs the driver about the action triggered. The system detects a child/passenger within the vehicle before triggering the action. The system informs the child/passenger about the action to be triggered. The system may request additional information/input from the occupants. The additional inputs include occupants such as child/passenger in the vehicle, distance to hospital, type of road (e.g., highway, toll road, etc.), condition of road, weather, vehicle limitations, GPS location, etc. The system evaluates the level of certainty for the action before triggering the action. The system requests additional conditions and vital signs from the occupant. The system requests the occupant to acknowledge the incapacitation state with a level of certainty. The system then executes the action (i.e., safety function).

The system communicates a command to an electric drive unit to engage autonomous driving when the driver is overruled. The electric drive unit takes control of the vehicle and drives to a nearby or indicated hospital. The system communicates a command to the electric drive unit to limit the speed, lock acceleration, and/or enable drive assistance. The system initiates a call to emergency services. The system iteratively re-evaluates incapacitation after a predefined period. The system confirms that the driver is capable of driving. In an embodiment, the system communicates a responsive request to the occupant. The system confirms that the driver is capable of driving upon receiving the response from the occupant within a predefined period. The system determines the level of certainty of the driver based on the sensitivity of the response received. The system enables the driver to retake control of the vehicle upon confirming that the driver state is normal. The system communicates a command to the electric drive unit to initiate safe stop of the vehicle. The system communicates a command to the electric drive unit to turn on the warning lights as a safety measure.

As an example, a high-level process flow for performing automatic intervention of a vehicle based on occupant facial expressions is described herein. The high-level process flow comprises the following technical steps. The processor communicates a command to the sensor module to monitor facial expressions of the one or more occupants. In an embodiment, the processor further communicates a command to the sensor module to monitor vital signs of the one or more occupants. The information sensed by the sensor module is fed to the processor. The processor classifies the facial expressions.

The processor, through one of algorithms (such as artificial intelligence, machine learning, large language models, NLP, etc.), detects the physiological state (e.g., medical conditions) of the occupant (e.g., driver) as normal state. The processor, through one of algorithms (such as artificial intelligence, machine learning, large language models, NLP, etc.), detects the physiological state (e.g., medical conditions) of the occupant (e.g., driver) as the incapacitation state with low certainty. The processor, through one of algorithms (such as artificial intelligence, machine learning, large language models, NLP, etc.), detects the physiological state (e.g., medical conditions) of the occupant (e.g., driver) as incapacitation state with high certainty. The algorithms may use facial landmarks such as the nose, eyes, eyebrows, cheek, and lip line. The processor requests the additional information from the other occupants for ensuring the driver state classification. The processor initiates the automatic interventions.

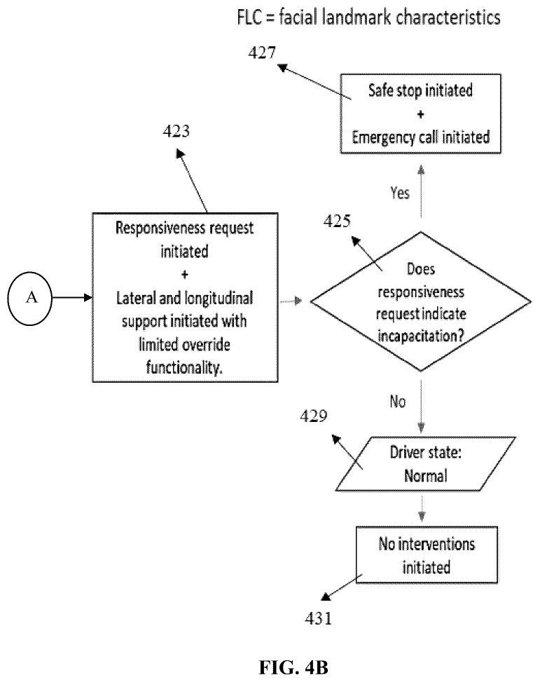

As an example, FIG. 5 illustrates a system monitoring whether there is a change in physiological state of an occupant, according to one or more embodiments. The system may be an in-vehicle system. The system comprises a sensor module. The sensor module comprises one or more cameras positioned to capture one or more images and one or more videos of the one or more occupants (e.g., driver, passenger, child, etc.). The one or more cameras may be positioned within the dashboard to capture facial expressions of the one or more occupants. The one or more cameras may continuously monitor the facial expressions of the one or more occupants. In one embodiment, the one or more cameras may intermittently monitor the facial expressions of the one or more occupants.

The processor receives the one or more images and/or one or more videos of the one or more occupants in real-time and extracts facial landmark characteristics from the facial expressions. The processor compares the facial landmark characteristics with the facial baseline landmark characteristics to determine the physiological state of the driver. The physiological state of the driver may be one of normal state, incapacitation state with low certainty, and incapacitation state with high certainty. In an embodiment, the sensor module comprises one or more sensors configured to monitor or sense the vital signs of the one or more occupants. The processor determines the medical conditions based on the vital signs. The processor via the artificial intelligence engine correlates the medical condition to the physiological state of the driver to ensure the health condition of the driver and to initiate automated vehicle intervention.

In order to correlate the facial expression to the change in physiological state (incapacitation state), it is necessary to understand a little bit about facial anatomy. For each pain-related expression, there is a movement of the one or more muscles or muscle groups which produces the key changes in the appearance of the face. The pain related expressions include at least one of brow lowering, cheek raising and lid compression, lid tightening, nose wrinkling, upper lip raising, eye closure, etc.

Brow Lowering: Brow lowering is produced by three muscles in the upper face—procerus (also referred to as depressor glabellae), depressor supercilii, and corrugator supercilii. Each muscle is fixed to the skull in the region of the area between the eyebrows. The individual strands attach to the facial skin in the forehead, above the eyebrow, or more medially, closer to the center of the forehead and to the inner corner of each brow. The facial action coding system (FACS)—based appearance changes for the facial expression with brow lowering includes:
The eyebrows are lowered
The eyebrows are drawn closer together
Vertical wrinkles may appear between the eyebrows or deepen in people in whom they are permanent
An oblique wrinkle or bulge may appear, running from the middle of the forehead above the middle of the eyebrow to the inner corner of the brow
   Intensity scoring: All the pain-related expressions vary in intensity. The FACS system for scoring intensity describes the movements according to a five-point intensity scale, beginning with a “trace” of the action (A), a “slight” action (B) and ranging up to “maximum” (E). Following are the specific FACS criteria for each intensity category:
A: the appearance changes indicating brow lowering are present, but not strong enough to score B
B: either the inner portion of the brow is lowered slightly, or the brows are pulled together slightly
C: the brows are lowered and pulled together. Either one of the lowering or pulling together movements is marked. The criteria for scoring intensity D are not met.
D: the brows are lowered and pulled together and at least one is severe
E: the lowering or pulling together of the brows is at a maximum.

Cheek Raising and Lid Compression: Cheek raising, and lid compression are produced by a muscle in the upper face—orbicularis oculi (pars orbitalis). This is a circular band of muscle surrounding the outer eye orbit. The outer perimeter of this muscle extends into the eyebrow and below the lower eye furrow into the upper portion of the cheek. Constriction of this muscle diminishes its circumference, drawing skin from the temple and the cheeks towards the eyes. The FACS-based appearance changes associated with this action include:
Skin is drawn towards the eye away from the temple and the cheeks
The infraorbital triangle (see below) is lifted, pulling the cheeks upward.
The skin surrounding the eye is pushed towards the eye socket, narrowing the eye aperture, and wrinkling the skin below the eye.
Crow's feet lines or wrinkles may appear, extending radially from the outer corners of the eye aperture.
The furrow of the lower eyelid deepens and the eyebrows lower.
   Intensity scoring:
A: the appearance changes indicating cheek raising and lid compression are present, but not strong enough to score B
B: Marked change on either criterion 1 or 2 below or slight on both 1 and 2 is sufficient to score B
   1. Crow's feet or wrinkles appear or become more prominent, or
   2. The infraorbital triangle is raised. This is indicated by cheek raising, deepening of the infraorbital furrow, bagging, or wrinkling under the eyes.
C: The crow's feet wrinkling and infraorbital triangle raising for criterion B are both present and at least marked, but the evidence is less than the criteria stated for D.
D: The crow's feet wrinkling and infraorbital triangle raising for criterion B are both present and at least severe, but the evidence is less than criteria stated for E.
E: The crow's feet wrinkling and infraorbital triangle raising are both present, with the infraorbital triangle and cheek raising in the maximum range.

Lid Tightening: Lid tightening is also produced by the contraction of the ring muscle that circles the eye orbit. In this case, however, it is the inner portion of orbicularis oculi (pars palpebralis) that produces the movement. Unlike cheek-raising/lid compression, the muscle responsible for lid tightening is narrower in circumference and runs the length of the inner eye orbit near the eyelids. The contraction of this muscle bunches the fibers encircling the eye. This results in the upper and lower eyelids and some adjacent skin below the eye being pulled together and towards the inner (medial) eye corner. This action has the effect of making someone appear as though they are squinting. The FACS-based appearance changes associated with this action include:
The eyelids are tightened, narrowing the eye aperture to form a squinting appearance.
The lower lid is raised, covering more of the eyeball than is usually covered.
The shape of the lower eyelid may change from a U to an ∩ shape.
Raising the lower lid causes a bulge to appear on the lower eyelid.
The lower eyelid furrow may become evident as a line or wrinkle, or if the furrow is a permanent part of the face, it becomes deeper.
   Intensity scoring:
A: appearance changes indicating lid tightening are present, but not strong enough to score B
B: 1. There is a slight narrowing of the eye aperture that is due primarily to the lower lid, or
   1. the lower lid is raised and the skin below the eye is drawn up and/or medially towards the inner corner of the eye slightly.
   or
   2. A slight bulge or pouch of the lower eyelid skin emerges as it is pushed up.
   If the lower lid does not move up, then criterion 1 must be marked not slight and criterion 3 must be met.
C: At least two features for B, narrowing the eye aperture, raising the lower lid, or bulging/pouching of the lower eyelid are present and at least one is marked, but the evidence is less than the criteria for D.
D: Narrowing of the eye aperture, raising of the lower lid, and bulging/pouching of the lower eyelid are all present and at least one of these is severe, but the evidence is less than the criteria for E.
E: 1. The narrowing of the eye aperture and raising and stretching of the lower lid are present and in the maximum range, hiding most of the iris and pulling skin below the lower eyelid towards the root of the nose, and
   2. tension in the eyelids and the bagging, bulging, or tensing of the lower eyelid is present and severe.
      Cheek-raising/lid compression and lid tightening are both derived from contraction of orbicularis oculi. This can make the two actions difficult to dissociate. Furthermore, both actions share appearance changes of narrowing the eye aperture and changing the appearance of the skin below the lower eyelid. However, there are some apparent differences:
The most significant difference is evidenced in the infraorbital triangle. The infraorbital triangle is raised in cheek-raising/lid compression but not in lid tightening: evident in more prominent raised cheeks and a more prominent or deepened infra-orbital furrow which takes on a more horizontal or crescent shape.
The bagging or wrinkling of the skin below the eye occurs more, extending further down the face, in cheek-raising/lid compression than in lid tightening.
The presence of crow's feet occurs with cheek-raising/lid compression, but not, or only to a limited extent (a few lines or wrinkles) with lid tightening.
A bulge may appear in the lower eyelid skin in both actions although it is due to a different action (pulling of the skin over the eyeball in lid tightening or pushing of the skin up by the drawing in action of cheek-raising/lid compression. The differences are distinct.

Nose wrinkling: Wrinkling of the nose is produced by levator labii superioris alaeque nasi (Latin for “lifter of the upper lip and wing of the nose”). This muscle innervates the skull between the inner eyebrow and the bridge of the nose. The strands of muscle run horizontally down each side of the nasal bridge and connect to the soft tissue of the face at the upper lip, just below the nasal openings. Contraction of this muscle pulls skin along the side of the nose upwards towards the root of the nose causing wrinkles to appear along the side of the nose and across the root of the nose. The FACS-based appearance changes associated with this action include:
Skin along the side of the nose is pulled upwards towards the root of the nose causing wrinkles to appear along the side and root of the nose.
The infraorbital triangle is drawn upwards causing the infraorbital furrow to wrinkle (or, if it is permanently etched, to deepen), and bunching or bagging the skin around the lower eyelid.
The medial portion of the eyebrows are lowered.
Pulls the center of the upper lip upwards. In an intense action the lips will part
   Intensity scoring:
A: the appearance changes indicating nose wrinkling are present, but not strong enough to score B (e.g., a trace of infraorbital triangle raises with skin drawn medially towards the eyes). Faint wrinkles on the nose are insufficient evidence as these may appear or deepen when skin is tightened by other facial actions.
B: The skin from the medial portion of the infraorbital triangle to the side of the nose is slightly drawn medially and upwards towards the bridge of the nose.
C: at least marked evidence of medial infraorbital triangle raise that draws skin towards the nasal bridge to form nose wrinkles, but the evidence is less than the criteria for D.
D: at least severe evidence of medial infraorbital triangle raise that draws skin towards the nasal bridge to form nose wrinkles, but the evidence is less than the criteria for E. The lips are usually pulled apart in intensity D and above.
E: nose wrinkling, infraorbital triangle raises drawing the skin towards the nasal bridge, and deepening infraorbital furrow are in the maximum range. The lips are usually parted during expression of higher intensity nose wrinkling.
   Nose wrinkling often involves some degree of brow lowering making the distinction between it and brow lowering difficult. In making the distinction between these actions, be aware that nose wrinkling involves primarily the nose wrinkling movement; whereas brow lowering involves a medial and angular movement of the eyebrows in addition to the pulling-down action.

Upper Lip Raising: Raising the upper lip is also produced by the levator muscle; in this case levator labii superioris. Levator labii superioris is a broad sheet of muscle innervating the skull beneath the lower eyelid at the zygomatic bone. The strands of muscle run down the length of the cheek connecting to soft tissue at the upper lip. This muscle is close to the muscle that produces nose wrinkling, but a little more lateral. Contraction pulls the skin of the cheeks upwards, drawing the center of the upper lip straight up. The FACS-based appearance changes associated with this action include:
The upper lip is raised. The center of the upper lip is drawn straight up, the outer portions of the upper lip are also drawn up but not to the same degree as is the center.
Angular bends occur in the upper lip and at the side of the nasal passage resulting in an upside-down U shape.
The infraorbital triangle is pushed up causing the infraorbital furrow to wrinkle or deepen if already evident in neutral.
The nasolabial furrow is deepened with the upper portion being furrowed, producing pouching at, and around, the upper lip and the nasal passages resulting in an appearance.
Widening and raising of the nostril wings.
   Intensity scoring:
A: the appearance changes indicating upper lip raising are present, but not strong enough to score B (e.g., a trace of pouching or bulging of the inner corner of the infraorbital triangle).
B: Slight pouching or bulging of the infraorbital triangle. If this pouch is permanent, it must increase slightly.
C: at least marked evidence of pouching or bulging of the inner corner of the infraorbital triangle, with lip raising evident and at least some other appearance based FACS changes present, but the evidence is less than that for D.
D: at least severe evidence of pouching or bulging of the inner corner of the infraorbital triangle, with all appearance based FACS changes being present, but the evidence is less than that for E.
E: All appearance based FACS changes are present and extreme to maximum.

Eye closure: The distinct, pain-related facial action is closing of the eyes. Eye closure is a product of relaxation in the levator palpebrae muscle. This muscle innervates behind the eye socket and attaches itself beneath the upper eyelid and above the lower eyelid. When the levator palpebrae contracts it raises the upper eyelid and lowers the lower eyelid effectively opening the eye. When relaxed the eyelids close. Thus, unlike that which has been seen in the other pain-related actions, in eye closure, when the muscle relaxes, the pain-related action occurs. The FACS-based appearance changes associated with this action include:
The eyelid droops down reducing the eye aperture.
Surface exposure of the upper eyelid increases. More of the upper eyelid becomes visible as the muscle of the upper eyelid relaxes.
The eyelid may not just be drooped but may exhibit limited tightening of the lids in conjunction with the pain-related actions of cheek raising/orbit closure and lid tightening.
Eye closure is distinct from blinking. The eyelids remain closed or appear to pause in the closed position during eye closure. This is in contrast to the occurrence of a blink where the eyelids close and open quickly without pause. In general, to score eye closure, the eyelid has to be closed for a duration of one half second or more.

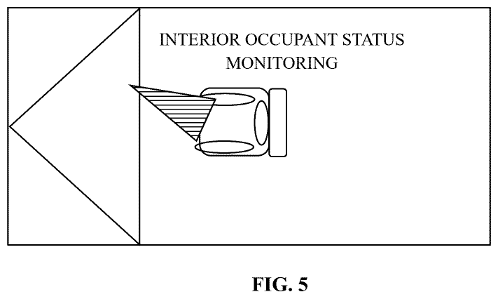

As an example, FIG. 6 illustrates a system detecting an incapacitation state of a driver with high certainty, according to one or more embodiments. The in-vehicle system comprises a sensor module. The sensor module comprises one or more cameras positioned to capture one or more images and/or one or more videos of the driver 604. In FIG. 6, the system using the one or more cameras captures the one or more facial expressions 602 of the driver 604. The one or more facial expressions 602 depict the incapacitation state of the driver 604 having high certainty.

The processor fetches specific instructions from the algorithms (e.g., artificial intelligence, machine learning, large language models, etc.) and executes the following technical steps. The processor analyzes the one or more images of the driver 604. The processor determines the facial expressions (e.g., brow lowering, cheek raising and lid compression, eye closure, etc.) from the one or more images. The processor compares the facial expressions with the facial baseline expressions to determine the deviations. The processor classifies the facial expressions based on the deviations. The processor then determines the incapacitation state of the driver 604 and determines the certainty level based on the deviation and classification. The processor may store the baseline expressions for each occupant (e.g., driver, passenger, child, etc.) in a database under his/her profile.

The processor, upon determining the incapacitation state of the driver 604, communicates a command to an electric drive unit 606 to take control of the vehicle if the driver is having the incapacitation state with high certainty. The processor communicates an alert or informs passengers that the electric drive unit 606 has taken control of the vehicle. In an embodiment, the processor communicates an alert or informing caretaker that the electric drive unit 606 has taken control of the vehicle. In an embodiment, the processor may inform the passenger/caretaker the current location of the vehicle and the destination of the vehicle. In an embodiment, the processor may inform the passenger/caretaker the real-time update regarding movement or maneuvering of the vehicle. The processor communicates with the electric drive unit based on the incapacitation state to execute a safety function. The safety function comprises one of initiating a safe stop, providing lateral and longitudinal support, calling emergency services, etc.

In one embodiment, the processor communicates a command to the sensor module to capture the facial expressions of the driver 604 after a predefined period of time. The processor iteratively determines the incapacitation state based on the current facial expression of the driver at that instant. The processor may communicate another command based on the present incapacitation state. The processor may provide the control to the driver 604 to operate the vehicle upon determining that the driver 604 is in the normal state in the subsequent iterations.

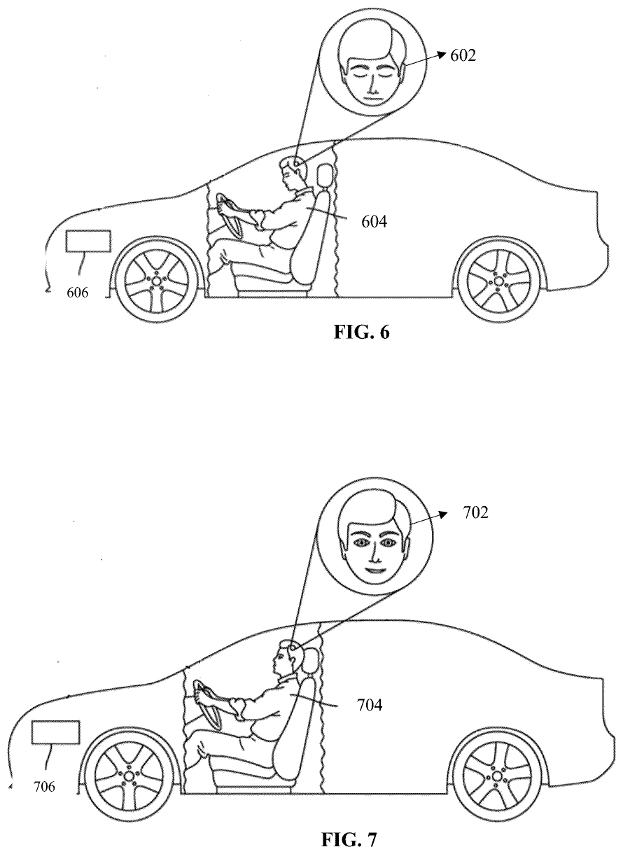

As an example, FIG. 7 illustrates a system detecting a normal state of a driver, according to one or more embodiments. The in-vehicle system comprises a sensor module. The sensor module comprises one or more cameras positioned to capture one or more images and/or one or more videos of the driver 704. In FIG. 7, the system using the one or more cameras captures the one or more facial expressions 702 of the driver 704. The one or more facial expressions 702 depict the normal state of the driver 704.

The processor fetches specific instructions from the algorithms (e.g., artificial intelligence, machine learning, large language models, etc.) and executes the following technical steps based on the specific instructions. The processor analyzes the one or more images of the driver 704. The processor determines the facial expressions (e.g., smile) from the one or more images. The processor compares the facial expressions with the facial baseline expressions to determine the deviations. The processor may store the facial baseline expressions for each occupant (e.g., driver, passenger, child, etc.) under his/her profile in a database. The processor classifies the facial expressions based on the deviations. The processor then determines that the driver 704 is in the normal state if there are very minimal deviations that are negotiable.

The processor communicates a command to an electric drive unit 706 to provide control of the vehicle to the driver 704 upon determining that the driver 704 is in the normal state. The processor then communicates with the electric drive unit to provide full override functionality to the driver 704.

In one embodiment, the processor communicates a command to the sensor module to capture the facial expressions of the driver 704 after a predefined period (e.g., 30 minutes). The processor then iteratively determines the incapacitation state based on the current facial expression of the driver at that instant (i.e., after 30 minutes). The processor may communicate another command based on the present incapacitation state. The processor may provide the control to the electric drive unit to operate the vehicle and prohibit override functionality to the driver 704 upon determining that the driver is in the incapacitation state in the subsequent iterations.

In an embodiment of the system, the machine learning model is configured to learn using labelled data using a supervised learning method, wherein the supervised learning method comprises logic using at least one of a decision trees, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a previous step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

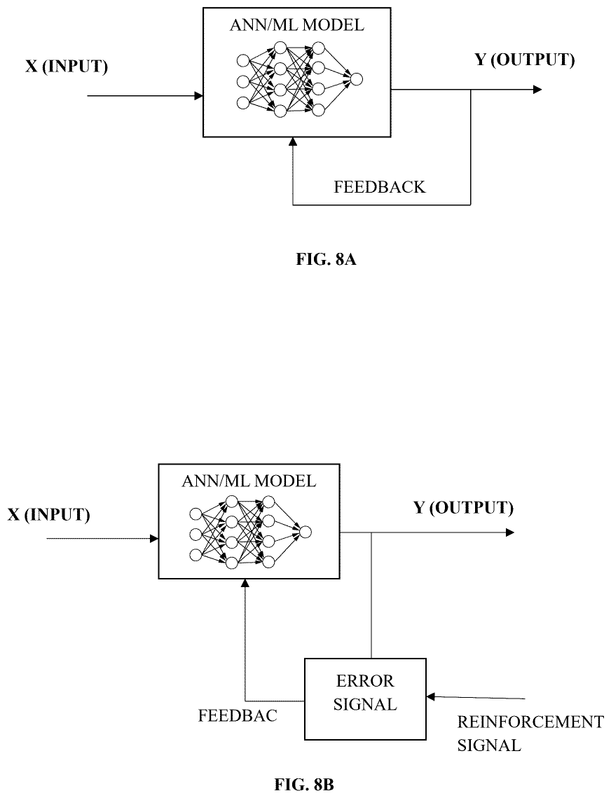

FIG. 8A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may predict or detect first pixels, and second pixels based on the input data. The output layer may also determine the contents to be displayed.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., contexts, contents) are used that are meant for the model to learn. Afterward, the model is tested using unlabelled data. By using, for example, deep learning and neural networks, the model can then make predictions on whether the desired concept/s (for e.g., contents to be displayed) are in unlabelled images. Each image is given a probability score where higher scores represent a higher level of confidence in the models' predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 8B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time. The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings, such terms are intended to be inclusive in a manner similar to the term “comprising,” as “comprising” is interpreted when employed as a transitional word in a claim.

Other specific forms may embody the present disclosure without departing from its spirit or characteristics. The embodiments described are in all respects illustrative and not restrictive. Therefore, the appended claims, rather than the description herein, indicate the scope of the disclosure. All variations which come within the meaning and range of equivalency of the claims are within their scope.

1-60. (canceled)

61. A system comprising:
a sensor module;
a processor storing instructions in non-transitory memory that, when executed, causes the processor to:
communicate a first command to the sensor module to capture at least one of a first image and a first video of one or more facial expressions of one or more occupants in a vehicle;
extract one or more facial landmark characteristics from the one or more facial expressions of the one or more occupants;
compare the one or more facial landmark characteristics with one or more facial baseline landmark characteristics of the one or more occupants to determine deviations of the one or more facial landmark characteristics against the one or more facial baseline landmark characteristics;
classify the one or more facial landmark characteristics based on the deviations exceeding threshold values;
determine a physiological state of the one or more occupants based on the classification of the one or more facial landmark characteristics; and
communicate a second command to an electric drive unit based on the physiological state to control the vehicle to ensure safety of the one or more occupants.

62. The system of claim 61, wherein the processor is operable to communicate a third command to the sensor module to capture at least one of a second image and a second video of one or more facial baseline expressions of the one or more occupants in a normal state.

63. The system of claim 62, wherein the processor is operable to extract the one or more facial baseline landmark characteristics from the one or more facial baseline expressions.

64. The system of claim 63, wherein the processor is operable to determine first coordinates of the one or more facial baseline landmark characteristics.

65. The system of claim 64, wherein the processor is operable to determine second coordinates of the one or more facial landmark characteristics.

66. The system of claim 65, wherein the processor is operable to compare the first coordinates and the second coordinates to determine the deviations of the one or more facial landmark characteristics against the one or more facial baseline landmark characteristics.

67. The system of claim 61, wherein the processor is operable to determine the physiological state as a first incapacitation state when at least eighty percent of the one or more facial landmark characteristics deviate against the one or more facial baseline landmark characteristics.

68. The system of claim 61, wherein the processor is operable to determine the physiological state as a second incapacitation state when at least sixty percent of the one or more facial landmark characteristics deviate against the one or more facial baseline landmark characteristics.

69. The system of claim 61, wherein the processor is operable to determine the physiological state as a normal state when at least seventy percent of the one or more facial landmark characteristics align with the one or more facial baseline landmark characteristics.

70. A method comprising:
communicating a first command to a sensor module to capture at least one of a first image and a first video of one or more facial expressions of one or more occupants in a vehicle;
extracting one or more facial landmark characteristics from the one or more facial expressions of the one or more occupants;
comparing the one or more facial landmark characteristics with one or more facial baseline landmark characteristics of the one or more occupants to determine deviations of the one or more facial landmark characteristics against the one or more facial baseline landmark characteristics;
classifying the one or more facial landmark characteristics based on the deviations exceeding threshold values;
determining a physiological state of the one or more occupants based on the classification of the one or more facial landmark characteristics; and
communicating a second command to an electric drive unit based on the physiological state to control the vehicle to ensure safety of the one or more occupants.

71. The method of claim 70, further comprising:
determining the physiological state as a second incapacitation state when at least sixty percent of the one or more facial landmark characteristics deviate against the one or more facial baseline landmark characteristics.

72. The method of claim 71, further comprising:
communicating a response request to the one or more occupants through a vehicle computer system; and
receiving a response from the one or more occupants through the vehicle computer system.

73. The method of claim 70, further comprising:
determining the physiological state as a first incapacitation state when at least eighty percent of the one or more facial landmark characteristics deviate against the one or more facial baseline landmark characteristics.

74. The method of claim 72, further comprising:
determining the physiological state as a first incapacitation state when a processor does not receive the response from the one or more occupants through the vehicle computer system for a predefined period of time.

75. The method of claim 72, further comprising:
executing one or more safety functions until a processor receives the response from the one or more occupants through the vehicle computer system.

76. A non-transitory computer readable storage medium comprising a sequence of instructions, which when executed by a processor causes:
communicating a first command to a sensor module to capture at least one of a first image and a first video of one or more facial expressions of one or more occupants in a vehicle;
extracting one or more facial landmark characteristics from the one or more facial expressions of the one or more occupants;
comparing the one or more facial landmark characteristics with one or more facial baseline landmark characteristics of the one or more occupants to determine deviations of the one or more facial landmark characteristics against the one or more facial baseline landmark characteristics;
classifying the one or more facial landmark characteristics based on the deviations exceeding threshold values;
determining a physiological state of the one or more occupants based on the classification of the one or more facial landmark characteristics; and
communicating a second command to an electric drive unit based on the physiological state to control the vehicle to ensure safety of the one or more occupants.

77. The non-transitory computer readable storage medium of claim 76, further causes:
communicating a response request to the one or more occupants through a vehicle computer system; and
receiving a response from the one or more occupants through the vehicle computer system.

78. The non-transitory computer readable storage medium of claim 77, further causes:
prohibiting overriding of one or more safety functions until the processor receives the response from the one or more occupants through the vehicle computer system.

79. The non-transitory computer readable storage medium of claim 78, further causes:
communicating a third command to the sensor module to measure at least one physiological parameter of the one or more occupants.

80. The non-transitory computer readable storage medium of claim 79, further causes:
determining the physiological state as a second incapacitation state when the at least one physiological parameter of the one or more occupants indicates that the physiological state is abnormal.
